(19) United States
(12) Patent Application Publication
(10) Pub. No.: US 2015/0207863 A1
(43) Pub. Date: Jul. 23, 2015

(54) Method for Providing Remote Server Content to a Web Browser of a User Computer through a Third Party Server, Web Browser, Third Party Server, and Computer-Readable Medium Related Thereto

(71) Applicants: Vivien Chappelier, Saint-Aubin d'Aubigne (FR); Clément Moreau, Issy Les Moulineaux (FR)

(72) Inventors: Vivien Chappelier, Saint-Aubin d'Aubigne (FR); Clément Moreau, Issy Les Moulineaux (FR)

(73) Assignee: Sculpteo, Vanves (FR)

(21) Appl. No.: 14/423,474

(22) PCT Filed: Sep. 29, 2011
(86) PCT No.: PCT/IB2011/002820

§ 371 Date: Feb. 24, 2015

(51) Int. Cl. H04L 29/08; G06F 17/30; H04L 29/06

(52) U.S. Cl. CPC H04L 67/10; H04L 67/42; G06F 17/30893

(57) ABSTRACT

A method for providing and displaying a remote server content to a user computer provided with a web browser, via a computer network connecting the remote server, the user computer and a third party server, the method comprising at least the following successive steps: a testing step wherein the ability of said web browser to display content is evaluated; a conforming step wherein, if the result of the testing step do not satisfy a criterion, a translation of the remote server content, depending on the result of the testing step, is requested to the third party server; and a displaying step in which content is displayed on the web browser.

### FIELD OF THE INVENTION

The instant invention relates to methods for providing remote content to a web browser of a user computer through a third party server, to web browser, to third party servers, and to computer-readable mediums related thereto.

### BACKGROUND OF THE INVENTION

A web browser installed on a user computer is a computer software typically used to retrieve remote content, translate it in a human readable form and display to the user. If the remote content is for instance a text message or an image, the user only have to specify remote content address to the web browser and said browser will be able to retrieve, translate and display this content to the user.

However, a growing number of contents such as videos, sounds or three-dimensional models can not be directly recognized and translated by common web browsers. A typical solution to this problem requires the user to download a piece of software usually called a “plug-in” that is associated with one or several content file formats and will be executed by the web browser each time it has to translate said unrecognized content.

This solution has a number of drawbacks for the content provider as well as for the user. Installing a plug-in can be a cumbersome operation for the user as it requires several steps including finding the plug-in, downloading it and installing it on his computer. These steps can require computer skill from the user, in particular when the plug-in's provider are expecting specific softwares to be previously installed on user computer which the user might have to find on his self. Installing a plug-in also slows down considerably the process of displaying said content and often discourages users to see said content.

Concerning the content provider, it has to ensure that a “plug-in” is available for its content's file format. The development of such a plug-in is generally a extensive task considering the range of web browsers in use and the range of user configurations to be compatible with. Maintaining such a plug-in up to date is also an expensive task which is necessary for the file format to be properly used by users.

An alternative method can be seen for example in U.S. Pat. No. 7,242,406 wherein a third party server generates various displayable representations of a three-dimensional model to be displayed on a user's mobile device without the requirement of installing a plug-in. In the method provided in U.S. Pat. No. 7,242,406 the third party server is used as proxy which implies that the entire remote content going to user's computer web browser has to transit through the third party server. Using a proxy thus also has several shortcomings; one being the delay added by the proxy, another is the dependence of the user on the proxy. The large bandwidth needed for the third party server is also expensive to the proxy provider.

There is thus a need for a method to provide remote content of various types and file formats in a way that is at the same time simple and efficient for the user and also inexpensive and easy to set up for the content provider.

### SUMMARY OF THE INVENTION

To this aim, the invention proposes a method for providing and displaying a remote server content to a user computer provided with a web browser, via a computer network connecting the remote server, the user computer and a third party server, the method comprising at least the following successive steps:
(a) a testing step wherein the ability of said web browser to display content is evaluated;
(b) a conforming step wherein, if the result of the testing step do not satisfy a criterion, a translation of the remote server content in a translated content depending on the result of the testing step is requested to the third party server; and
(c) a displaying step in which a content chosen in the list comprising the remote server content and the translated content is displayed on the web browser.

The user may thus retrieve and display content on its computer's web browser in a very simple way and without having to install any piece of software.

In various embodiments of the method, one or more of the following provisions may be used:
the step of testing comprises testing the ability of the web browser to display at least one file format;
the step of testing comprises checking the presence of at least one plug-in in the web browser;
the step of testing is accomplished trough the execution of a script by the web browser;
the script used in the step of testing consists in Javascript or VBScript commands;
the step of conforming comprises at least the following successive operations:
(a) a request operation wherein the web browser send a request concerning the remote server content to the third party server, the request being based on the result of the testing step;
(b) a retrieval operation wherein the third party server retrieves the remote server content;
(c) a translation operation wherein the third party server translates the remote server content in a translated content, based on the request received during the request operation; and
(d) a sending operation wherein the third party server send back the translated content to the web browser.
the translation operation comprises operations chosen from a list comprising: rasterizing a three-dimensional content, reducing the complexity of a three-dimensional model, reducing the number of triangle of a three-dimensional model, reducing the size of the texturing images of a three-dimensional model and compressing the remote server content.
the step of conforming is accomplished by using asynchronous communication.
the step of conforming involves using of Javascript or VBScript commands.
the remote server content consists in a three-dimensional model.
the translated content is chosen in the list comprising an image and a three-dimensional model.

### BRIEF DESCRIPTION OF THE DRAWINGS

Other characteristics and advantages of the invention will readily appear from the following description of one of its embodiments, provided as a non-limitative examples, and of the accompanying drawings.

On the drawings:

FIG. 1 illustrates an embodiment of a system for using a method of the invention,

FIG. 2 is a flowchart illustrating an embodiment of the method according to the invention.

FIG. 3 is a flowchart illustrating an embodiment of the conforming step according to the invention.

On the different Figures, the same reference signs designate like or similar elements.

### DETAILED DESCRIPTION

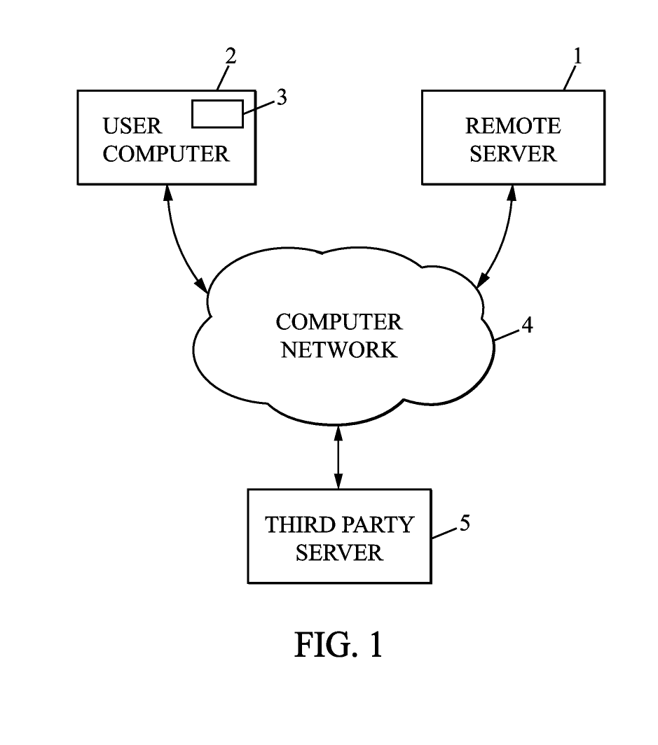

As detailed on FIG. 1, the invention provides a method for providing and displaying content from a remote server 1 to a user computer (PC) or other electronic device 2 provided with a web browser 3, via a computer network 4 connecting the remote server 1, the user computer 2 and a third party server 5.

The remote server 1 and the third party server 5 may include several physical servers and the memories and computing processors of these servers can be constituted by memory devices and computing units separated from any physical server.

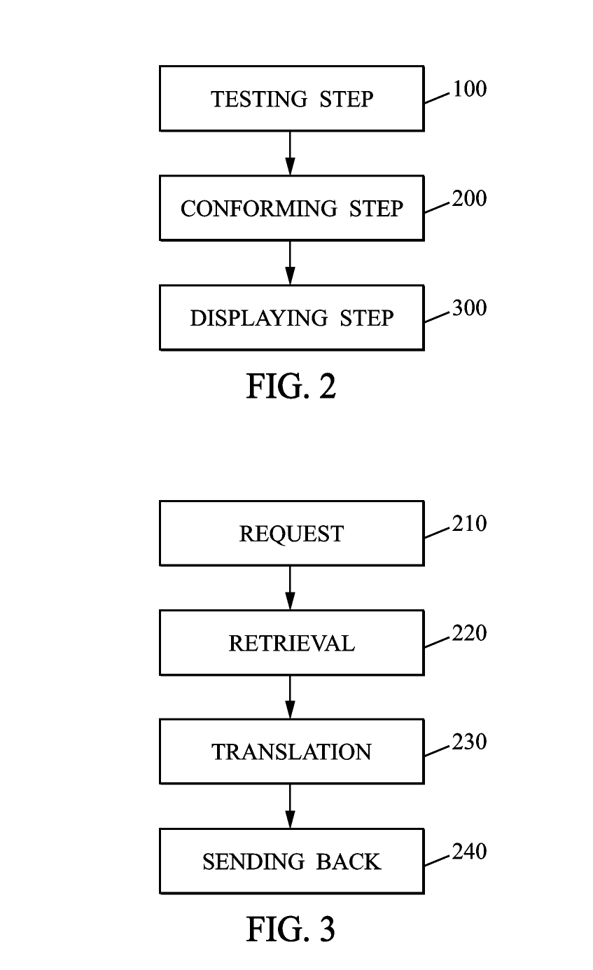

Referring to FIG. 2, in a particular embodiment of the present invention, a first testing step 100 consists in an evaluation of the ability of said web browser 3 to display content.

This step may comprise an operation of testing the ability of the web browser 3 to display a list of file formats. It may also comprise an operation consisting in checking the presence of a list of plug-ins in the web browser 3.

In a preferred embodiment, this step 100 is accomplished through the execution of a script by the web browser 3. This script can for example consist in Javascript or VBScript commands.

In a variant of the invention, said script can detect the generation of an error when trying to display a specific content on the web browser 3.

In a preferred embodiment, said script can be included on a web page through the use of a tag, for example an html tag. This way, the inclusion of the script is easy and convenient for the web developer or the content provider.

The testing step 100 gives a result indicating whether the remote server 1 content can be displayed on the web browser 3.

In a conforming step 200, the remote server content will be made to comply with the web browser 3. If the result of the testing step 100 does not satisfy a criterion, the remote browser content will be translated in a translated content to be displayed on the web browser 3. If the result of the testing step 100 satisfies said criterion, the content doesn't have to be translated.

The criterion can be for example, the ability of the web browser 3 to display a specific file format; it can also depend on the size or the complexity of the content and involve the software or hardware configuration of the user computer 2.

The criterion indicates whether the web browser 3 can display the content to the user in satisfactory conditions. If the criterion is not satisfied, the content has to be translated before it can be displayed on the web browser 3.

The conforming step can be accomplished by using asynchronous communication, for instance through the use of Javascript or VBScript commands. The conforming step 200 can be accomplished by the same script used for the accomplishment of the testing step 100.

Eventually, during a displaying step 300, content is displayed on the web browser 3. This content can be the remote server content or the translated content obtained during the conforming step 200.

The conforming step 200 can comprise several successive operations that are detailed on FIG. 3.

During a request operation 210, the web browser 3 sends a request concerning the remote server 1 content to the third party server 5, the request being based on the result of the testing step 100.

The third party server 5 then conducts a retrieval operation 220 wherein it retrieves the remote server 1 content indicated in the request.

In a translation operation 230, the third party server 5 translates the remote server 1 content in a translated content, based on the request.

In a sending operation 240, the third party server 5 sends back the translated content to the web browser 3.

The translation operation 230 can consist in a translation from a specific file format to another. In a preferred embodiment, it consists in rasterizing a three-dimensional content. It can also comprise reducing the complexity of a three-dimensional model, reducing the number of triangle of a three-dimensional model, reducing the size of the texturing images of a three-dimensional model and compressing the remote server content. The content can be an image, a three-dimensional model or any piece of content that can be provided on a computer network 4.

1. A method for providing and displaying a remote server content to a user computer provided with a web browser, via a computer network connecting the remote server, the user computer and a third party server, the method comprising at least the following successive steps:
a testing step wherein the ability of said web browser to display content is evaluated;
a conforming step wherein, if the result of the testing step do not satisfy a criterion, a translation of the remote server content in a translated content depending on the result of the testing step is requested to the third party server; and
a displaying step in which a content chosen in the list comprising the remote server content and the translated content is displayed on the web browser.

2. The method according to claim 1, wherein the step of testing comprises testing the ability of the web browser to display at least one file format.

3. The method according to claim 1, wherein the step of testing comprises checking the presence of at least one plug-in in the web browser.

4. The method according to claim 1, wherein the step of testing is accomplished trough the execution of a script by the web browser.

5. The method according to claim 4, wherein the script used in the step of testing includes Javascript or VBScript commands.

6. The method according to claim 1, wherein the step of conforming comprises at least the following successive operations:
a request operation wherein the web browser send a request concerning the remote server content to the third party server, the request being based on the result of the testing step;
a retrieval operation wherein the third party server retrieves the remote server content;
a translation operation wherein the third party server translates the remote server content in a translated content, based on the request received during the request operation; and
a sending operation wherein the third party server send back the translated content to the web browser.

7. A method according to claim 6, wherein the translation operation comprises operations chosen from a list comprising: rasterizing a three-dimensional content, reducing the complexity of a three-dimensional model, reducing the number of triangle of a three-dimensional model, reducing the size of the texturing images of a three-dimensional model and compressing the remote server content.

8. The method according to claim 1, wherein the step of conforming is accomplished by using asynchronous communication.

9. The method according to claim 1, wherein the step of conforming involves using of Javascript or VBScript commands.

10. The method according to claim 1, wherein the remote server content consists in a three-dimensional model.

11. The method according to claim 1, wherein the translated content is chosen in the list comprising an image and a three-dimensional model.

12. A web browser programmed to perform actions comprising:
evaluating the ability of the web browser to display content;
requesting a translation of a remote server content in a translated content depending on the result of the evaluating step to the third party server; and
displaying on the web browser a content chosen in the list comprising the remote server content and the translated content.

13. A third party server programmed to perform actions comprising:
translating a remote server content in a translated content depending on the result of an evaluating step performed on a web browser.

14. A computer-readable medium having computer-executable instructions, which when executed by a web browser, perform actions comprising:
evaluating the ability of the web browser to display content;
requesting a translation of a remote server content in a translated content depending on the result of the evaluating step to the third party server; and
displaying on the web browser a content chosen in the list comprising the remote server content and the translated content.

15. A computer-readable medium having computer-executable instructions, which when executed on a third party server, perform actions comprising:
translating a remote server content in a translated content depending on the result of an evaluating step performed on a web browser.
